(19) United States
(12) Patent Application Publication
(10) Pub. No.: US 2006/0237588 A1
(43) Pub. Date: Oct. 26, 2006

(54) Composite structural member having an undulating web and method for forming the same

(75) Inventor: Max U. Kismarton, Seattle, WA (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/096,795

(22) Filed: Mar. 31, 2005

(51) Int. Cl. B64C 1/00; E04C 3/30

(52) U.S. Cl. 244/119; 52/729.3

(57) ABSTRACT

Composite structural members and methods for forming the same are disclosed. In one embodiment, a composite structural member includes a central structural portion that extends in a first direction and having a first flange portion and a second flange portion that are spaced apart in a second direction perpendicular to the first direction by a web portion, the web portion further including a periodic or a non-periodic undulation extending in the first direction. A first reinforced polymer-based substrate is fixedly coupled to the first flange portion, and a second reinforced polymer-based substrate is fixedly coupled to the second flange portion.

### CROSS REFERENCE TO RELATED APPLICATIONS

This patent application is related to the following co-pending, commonly-owned U.S. patent applications, which applications are hereby incorporated by reference: U.S. patent application Ser. No. (to be determined) entitled “Composite Structural Member and Method for Forming the Same”, filed under Attorney Docket No. BING-1-1151; U.S. patent application Ser. No. (to be determined) entitled “Hybrid Fiberglass Composite Structures and Methods for Forming the Same”, filed under Attorney Docket No. BING-1-1149; U.S. patent application Ser. No. (to be determined) entitled “Multi-Axial Laminate Composite Structures and Methods of Forming the Same” filed under Attorney Docket No. BING-1-1150.

### FIELD OF THE INVENTION

This invention relates generally to structural components, and more particularly, to composite structural members.

### BACKGROUND OF THE INVENTION

Structural members are available in a wide variety of configurations to provide structural support under a variety of loading conditions. For example, the wing and empennage surfaces of an aircraft typically include parallel and span-wise oriented structural members called stringers that impart flexural stiffness to the wing and empennage surfaces. Typically, a structural member is fabricated from a metal, such as aluminum, steel or titanium, and is configured to resist flexural and/or shear loads. Accordingly, the structural member includes a planar web portion that is generally oriented in a direction approximately parallel to the applied load so that the web portion offers resistance to a bending moment generated by the load. A flange portion may be positioned on one or both of the longitudinal edges of the web portion in order to provide resistance to localized failure of the web portion due to lateral buckling. The flange portion further allows the structural member to be incorporated into a structure by providing an attachment and/or supporting surface for other adjacent members comprising the structure.

Reinforced polymer-based materials are also available that may be used to form various structural members, and are frequently used as a substitute for metals, particularly in applications where relatively low weight and high mechanical strength is desired. As a result, reinforced polymer-based materials are widely used in a variety of commercial and military aircraft, terrestrial vehicles and consumer products. The material is generally comprised of a network of reinforcing fibers that are generally applied in layers, and a polymeric resin that substantially wets the reinforcing fibers to form an intimate contact between the resin and the reinforcing fibers. The material may then be formed into a structural component by a variety of known forming methods, such as an extrusion process or other forming processes.

Structural members formed from reinforced polymer-based materials are generally more expensive to fabricate, and more difficult to inspect and repair than corresponding structural members formed from metals, such as a ferrous metal, or various non-ferrous metals, such as aluminum and titanium. In particular, repair methods for metallic structural members that have sustained in-service damage due to excessive loading, or have sustained fatigue and/or corrosive damage while in service are well developed.

What is required is a structural member that is easily and inexpensively fabricated, provides a favorable flexural strength to weight ratio in comparison to conventional structural members, and may be easily inspected and repaired.

### SUMMARY

Composite structural members and methods for forming the same are disclosed. In one aspect, a composite structural member includes a central structural portion that extends in a first direction and having a first flange portion and a second flange portion that are spaced apart in a second direction perpendicular to the first direction by a web portion, the web portion further including a periodic or non-periodic undulation extending in the first direction. A first reinforced polymer-based substrate is fixedly coupled to the first flange portion, and a second reinforced polymer-based substrate is fixedly coupled to the second flange portion.

### BRIEF DESCRIPTION OF THE DRAWINGS

The disclosed embodiments of the present invention are described in detail below with reference to the following drawings.

FIG. 1 is an exploded, partial isometric view of composite structural member according to an embodiment of the invention;

FIG. 2 is a partial cross sectional view of the web portion viewed along the cross section 2-2 shown in FIG. 1;

FIG. 3 is a partial cross sectional view of a web portion viewed along the cross section 2-2 shown in FIG. 1, according to another embodiment of the invention;

FIG. 4 is another partial cross sectional view of a web portion viewed along the cross section 2-2 shown in FIG. 1, according to still another embodiment of the invention;

FIG. 5 is a schematic view of a ply arrangement for a plurality of reinforcing fibers included in at least one of the first reinforced polymer-based substrate and the second reinforced polymer-based substrate of FIG. 1, according to still another embodiment of the invention;

FIG. 5A is a ply arrangement for a plurality of reinforcing fibers according to another embodiment of the invention;

FIG. 7 is a flowchart that shows a method of making a composite structural member according to still yet another embodiment of the invention; and

FIG. 8 is a side elevation view of an aircraft having one or more of the disclosed embodiments of the present invention.

### DETAILED DESCRIPTION

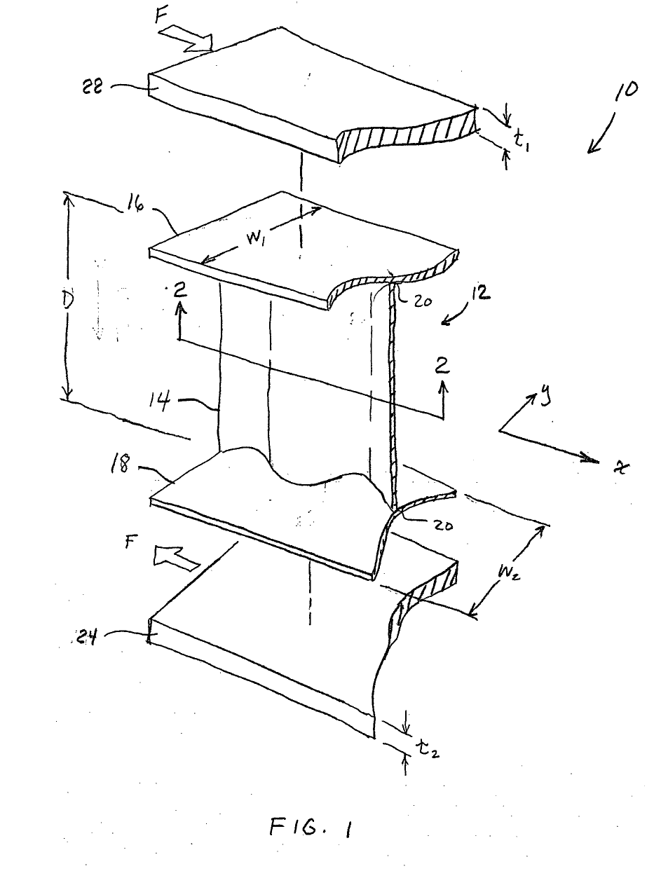

The present invention relates to composite structural members and methods for forming such members. Many specific details of certain embodiments of the invention are set forth in the following description and in FIGS. 1 through 8 to provide a thorough understanding of such embodiments. One skilled in the art, however, will understand that the present invention may have additional embodiments, or that the present invention may be practiced without several of the details described in the following description. In the present discussion, it is understood that a composite structural member refers to a member comprised of dissimilar materials, and that the term “reinforced polymer-based material” includes various non-homogeneous polymer-based materials, commonly referred to as “reinforced composites”, “carbon-fiber composites”, or still other terms known in the art.

FIG. 1 is an exploded, partial isometric view of composite structural member 10 according to an embodiment of the invention. The composite structural member 10 includes a central structural portion 12 having a web portion 14 that is positioned between a first flange portion 16 and an opposing second flange portion 18. The web portion 14 may have a predetermined depth D in order to provide a desired resistance to shear loading in response to an applied load F, and is also formed to have a generally undulating shape, as will be described in greater detail below. The first flange portion 16 and the second flange portion 18 are generally planar members having predetermined widths W₁ and W₂, respectively. The opposing edges 20 of the web portion 14 are positioned on the first flange portion 16 and the second flange portion 18, and are fixedly joined to the first flange portion 16 and the second flange portion 18. The web portion 14 and the first flange portion 16 and the second flange portion 18 are generally formed from a rigid ferrous or non-ferrous material. In one particular embodiment, the central structural portion 12 is fabricated from titanium, and the web-portion 14 is formed to have approximately sinusoidal undulations (or corrugations). Although the central structural portion 12 shown in FIG. 1 includes a web portion 14 having an approximately constant depth D, it is understood that the depth D may be variable either continuously or even non-continuously, as the member 10 extends in an x-direction. It is further understood that the width W₁ of the first flange portion 16 and the width W₂ of the second flange portion 18 may also vary in a continuous or a non-continuous manner as the member 10 extends in the x-direction.

Still referring to FIG. 1, the composite structural member 10 also includes a first reinforced polymer-based substrate 22 having a thickness t₁ that is fixedly coupled to the first flange portion 16, and a second reinforced polymer-based substrate 24 having a thickness t₂ that is fixedly coupled to the second flange portion 18. The first reinforced polymer-based substrate 22 and the second reinforced polymer-based substrate 24 may be coupled to the respective first and second flange portions 16 and 18 in any suitable manner, including using a suitable adhesive compound, or by means of mechanical fastening devices. For example, and in one particular embodiment, a multi-part epoxy compound may be used to bond the first reinforced polymer-based substrate 22 and the second reinforced polymer-based substrate 24 to the respective first and second flange portions 16 and 18. One suitable epoxy adhesive is the FM-300 structural adhesive available from Cytec Industries, Incorporated of West Paterson, N.J., although other suitable alternatives exist.

In addition, the first reinforced polymer-based substrate 22 and the second reinforced polymer-based substrate 24 may be fabricated from materials that include fiber-reinforced materials. In a particular embodiment, the first reinforced polymer-based substrate 22 and the second reinforced polymer-based substrate 24 include graphite fibers that reinforce the first reinforced polymer-based substrate 22 and the second reinforced polymer-based substrate 24. In other particular embodiments, the graphite fibers are disposed in the first reinforced polymer-based substrate 22 and the second reinforced polymer-based substrate 24 according to a predetermined pattern, which will be described in greater detail below. Although the composite structural member_10 includes a first reinforced polymer-based substrate 22 and a second reinforced polymer-based substrate 24 having approximately constant thicknesses t₁ and t₂, respectively, it is understood that the thicknesses t₁ and t₂ may be variable either continuously or even non-continuously, as the member 10 extends in an x-direction. Further, the substrate 22 and/or the substrate 24 may extend in a y-direction to any desired length.

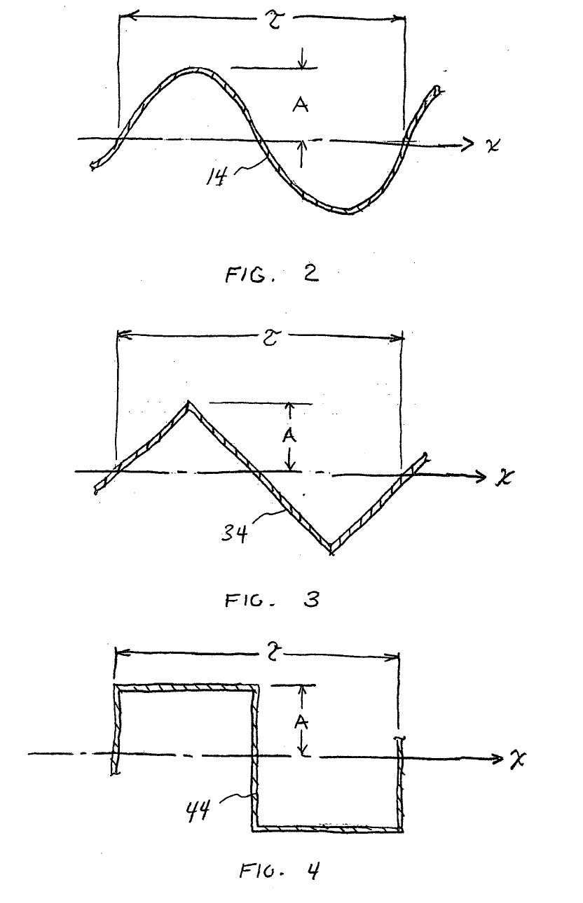

FIG. 2 is a partial cross sectional view of the web portion 14 viewed along the cross section 2-2 shown in FIG. 1. The web portion 14 has a generally sinusoidal cross sectional shape having a period τ, and amplitude A. The period τ and the amplitude A may be approximately constant as the composite structural member 10 of FIG. 1 extends in the x-direction, or at least one of the period τ and the amplitude A may vary either continuously or non-continuously as the member 10 extends in the x-direction. Flat portions (not shown in FIG. 2) may also be incorporated into the continuous web portion 14 to support the attachment of other structural members. In another embodiment, the web portion 14 may be a compound waveform. For example, a first sinusoidal waveform may include another generally sinusoidal second waveform superimposed on the first waveform.

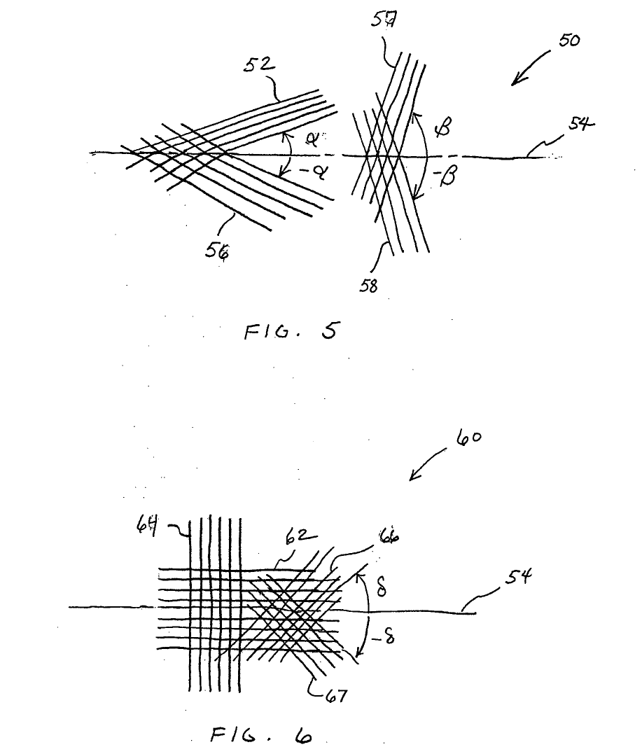

FIG. 3 is a partial cross sectional view of a web portion 34 viewed along the cross section 2-2 shown in FIG. 1, according to another embodiment of the invention. The web-portion 34 has a generally triangular-wave cross sectional shape, and has a period τ, and amplitude A. As in the previous embodiment, the period τ and the amplitude A may be approximately constant as the composite structural member 10 extends in the x-direction, or at least one of the period τ and the amplitude A may vary either continuously or non-continuously as the member 10 extends in the x-direction.

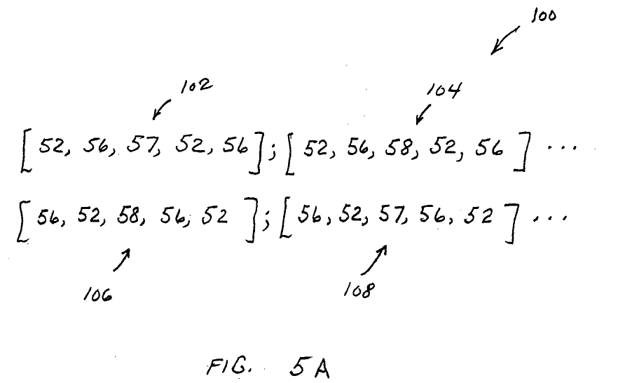

FIG. 4 is another partial cross sectional view of a web portion 44 viewed along the cross section 2-2 shown in FIG. 1, according to still another embodiment of the invention. The web-portion 44 has a generally square-wave cross sectional shape, and has a period τ, and amplitude A. As in the previous embodiments, the period τ and the amplitude A may be approximately constant as the composite structural member 10 extends in the x-direction, or at least one of the period τ and the amplitude A may vary either continuously or non-continuously as the member 10 extends in the x-direction. Although FIG. 2 through FIG. 4 shows regular periodic cross-sectional shapes for the web portion 14 of FIG. 1, it is understood that other cross sectional shapes are possible. For example, it is understood that other periodic cross sectional shapes may be generated by combining sine and cosine functions in a Fourier series expansion to generate a desired periodic function.

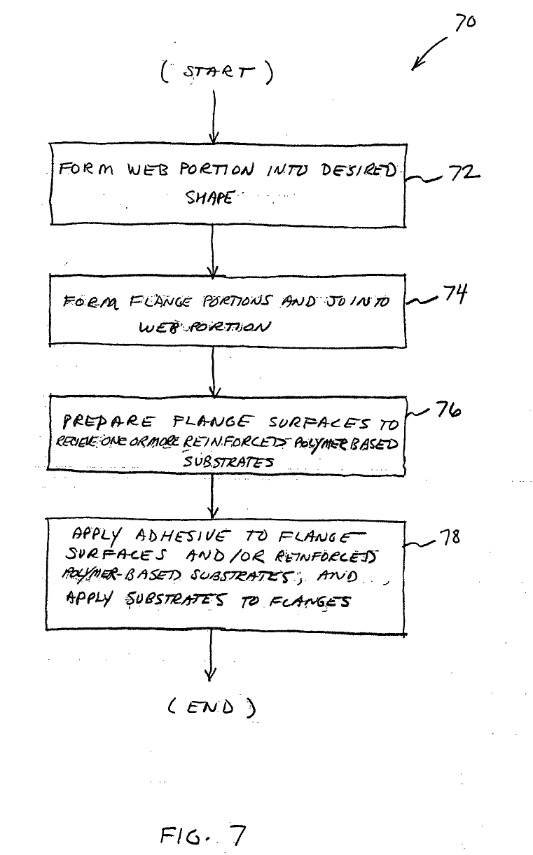

FIG. 5 is a schematic view of a ply arrangement 50 for a plurality of reinforcing fibers included in at least one of the first reinforced polymer-based substrate 22 and the second reinforced polymer-based substrate 24 of FIG. 1, according to still another embodiment of the invention. The ply arrangement 50 includes a first layer of reinforcing fibers 52 that are oriented at an angle a with respect to a predetermined orientation direction 54, and a second layer of reinforcing fibers 56 that are oriented at an angle −α with respect to the orientation direction 54. The first layer of reinforcing fibers 52 and the second layer of reinforcing fibers 56 are applied to at least one of the first reinforced polymer-based substrate 22 and the second reinforced polymer-based substrate 24 of FIG. 1 in adjacent layers. In one particular embodiment, α is approximately about five degrees.

The ply arrangement 50 further includes a third layer of reinforcing fibers 57 that are oriented at an angle β with respect to a predetermined orientation direction 54, and a fourth layer of reinforcing fibers 58 that are oriented at an angle −β with respect to the orientation direction 54. The third layer of reinforcing fibers 57 and the fourth layer of reinforcing fibers 58 are also applied to at least one of the first reinforced polymer-based substrate 22 and the second reinforced polymer-based substrate 24 of FIG. 1 in adjacent layers. In one particular embodiment, β is approximately about sixty-five degrees. The ply arrangement 50 may include the first and second layers 52 and 56, and the third and fourth layers 57 and 58 in any predetermined ratio, but in a particular embodiment, the ratio is approximately 80% first and second layers of reinforcing fibers 52 and 56, with the balance being the third and fourth layers of reinforcing fibers 57 and 58.

Referring now to FIG. 5A, a ply arrangement 100 according to another embodiment of the invention includes a first ply group 102, a second ply group 104, a third ply group 106, and a fourth ply group 104. The numbers within each of the ply groups 102, 104, 106 and 108 correspond to the plies shown in FIG. 5. For example, the first ply group 102 includes the first layer of reinforcing fibers 52 and the second layer of reinforcing fibers 56, the third layer of reinforcing fibers 57, and is followed by another first layer of reinforcing fibers 52 and second layer of reinforcing fibers 56. The first group 102, the second group 104, the third group 106 and the fourth group 108 may be applied in any desired combination and may be repeated to any desired degree. In one particular embodiment, a structure includes at least about 60% of the first layer of reinforcing fibers 52 and the second layer of reinforcing fibers 56.

FIG. 6 is a schematic view of a ply arrangement 60 for a plurality of reinforcing fibers included in at least one of the first reinforced polymer-based substrate 22 and the second reinforced polymer-based substrate 24 of FIG. 1, according to still yet another embodiment of the invention. The ply arrangement 60 includes a first layer of reinforcing fibers 62 that are approximately aligned with the predetermined orientation direction 54, and a second layer of reinforcing fibers 64 that are approximately perpendicular to the orientation direction 54. The ply arrangement 60 also includes a third layer of reinforcing fibers 66 that are oriented at an intermediate angle δ with respect to the orientation direction 54, and a fourth layer of reinforcing fibers 67 that are oriented at an intermediate angle −δ with respect to the orientation direction 54. The first layer of reinforcing fibers 62 and the second layer of reinforcing fibers 64 may be applied in adjacent layers, with the third layer 66 and the fourth layer 67 applied either above or below the adjacent layers, or alternately, the third layer of reinforcing fibers 66 and the fourth layer of reinforcing fibers 67 may be interposed between the first layer 62 and the second layer 64. In one particular embodiment, the third layer 66 and the fourth layer 67 are interposed between the first layer 62 and the second layer 64, and 6 is approximately about forty-five degrees.

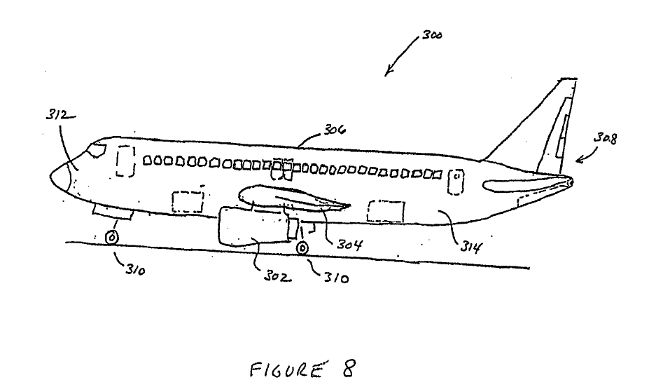

FIG. 7 is a flowchart that shows a method 70 of making a composite structural member according to still yet another embodiment of the invention. At block 72, the web portion 14 (FIG. 1) is formed into a desired periodic or non-periodic shape. The web portion 14 may be formed by rolling, stamping, or by other well-known metal forming methods. At block 74, the first flange portion 16 and the second flange portion 18 are formed by cutting, shearing, or by other methods. The first flange portion 16 and the second flange portion 18 may then be joined to the web-portion 14 by welding. In one particular embodiment, the first flange portion 16 and the second flange portion 18 are welded to the web portion 14 using a laser welding apparatus. Alternately, the first flange portion 16 and the second flange portion 18 may be joined to the web portion 14 using a brazing process, or using a super-plastic forming process.

At block 76, surfaces of the first flange portion 16 and the second flange portion 18 are chemically prepared to receive the first reinforced polymer-based substrate 22 and the second reinforced polymer-based substrate 24, respectively. In one particular embodiment, the surfaces are prepared by subjecting the surfaces to an acid etch, that is followed by the application of a conversion coating to the surfaces. In another particular embodiment, the surfaces are prepared using a sol-gel method to improve the surface adhesion properties of the first flange portion 16, and the second flange portion 18. One suitable sol-gel method is disclosed in U.S. Pat. No. 6,037,060 to Blohowiak, et al., entitled “SOL FOR BONDING AN EPOXY TO ALUMINUM OR TITANIUM ALLOYS”, which patent is incorporated herein by reference.

At block 78, an adhesive is applied to the surfaces prepared at block 76, and the first reinforced polymer-based substrate 22 and the second reinforced polymer-based substrate 24 are positioned on the flanges. The substrates 22 and 24 may be held in place by applying pressure on the first reinforced polymer-based substrate 22 and the second reinforced polymer-based substrate 24 until the adhesive is cured.

Those skilled in the art will also readily recognize that the foregoing embodiments may be incorporated into a wide variety of different systems. Referring now in particular to FIG. 8, a side elevation view of an aircraft 300 having one or more of the disclosed embodiments of the present invention is shown. The aircraft 300 generally includes a variety of components and subsystems known in the pertinent art, which in the interest of brevity, will not be described in detail. For example, the aircraft 300 generally includes one or more propulsion units 302 that are coupled to wing assemblies 304, or alternately, to a fuselage 306 or even other portions of the aircraft 300. Additionally, the aircraft 300 also includes a tail assembly 308 and a landing assembly 310 coupled to the fuselage 306, and a flight control system 312 (not shown in FIG. 8), as well as a plurality of other electrical, mechanical and electromechanical systems that cooperatively perform a variety of tasks necessary for the operation of the aircraft 300.

With reference still to FIG. 8, the aircraft 300 may include one or more of the embodiments of the composite structural member 314 according to the present invention, which may be incorporated into various structural portions of the aircraft 300. For example, the various disclosed embodiments may be used to form stringers in the wing assemblies 304 and/or surfaces in the tail assembly 308, or may be used to form floor beams (not shown in FIG. 8) positioned within the fuselage 306.

The aircraft 300 is generally representative of a commercial passenger aircraft, which may include, for example, the 737, 747, 757, 767 and 777 commercial passenger aircraft available from The Boeing Company of Chicago, Ill. In alternate embodiments, the present invention may also be incorporated into flight vehicles of other types. Examples of such flight vehicles include manned or unmanned military aircraft, rotary wing aircraft, or even ballistic flight vehicles, as illustrated more fully in various descriptive volumes, such as Jane's All The World's Aircraft, available from Jane's Information Group, Ltd. of Coulsdon, Surrey, UK.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

What is claimed is:

1. A composite structural member, comprising:
a central structural portion that extends in a first direction and having a first flange portion and a second flange portion that are spaced apart in a second direction perpendicular to the first direction by a web portion, the web portion further including a non-planar portion extending in the first direction;
a first reinforced polymer-based substrate fixedly coupled to the first flange portion; and
a second reinforced polymer-based substrate fixedly coupled to the second flange portion.

2. The composite structural member of claim 1, wherein the non-planar portion comprises at least one of a periodic undulation portion and a non-periodic undulation portion.

3. The composite structural member of claim 1, wherein the non-planar portion includes a periodic undulation comprising at least one of an approximately sinusoidal undulation, a triangular wave undulation and a square wave undulation.

4. The composite structural member of claim 1, wherein a depth of the web portion extending between the first flange and the second flange varies in the first direction.

5. The composite structural member of claim 1, wherein the non-planar portion has a period and an amplitude and at least one of the period and the amplitude is varied in the first direction.

6. The composite structural member of claim 1, wherein at least one of the first reinforced polymer-based substrate and the second reinforced polymer-based substrate is a fiber reinforced substrate having more than one layer of fibers positioned in the substrate in a predetermined pattern.

7. The composite structural member of claim 6, wherein the predetermined pattern further comprises a first layer oriented at an angle α with respect to a selected reference direction, a second layer oriented at an angle −α with respect to the reference direction, a third layer oriented at an angle β with respect to a selected reference direction, and a fourth layer oriented at an angle −β with respect to the reference direction.

8. The composite structural member of claim 7, wherein the angle a is approximately five degrees, and the angle β is approximately sixty-five degrees.

9. The composite structural member of claim 7, wherein the predetermined pattern further comprises at least about 80% first and second layers.

10. The composite structural member of claim 6, wherein the predetermined pattern comprises a first layer that is approximately aligned with a selected reference direction, a second layer that is approximately perpendicular to the reference direction, and a third layer that is oriented at an angle δ that is intermediate between the orientation of the first layer and the second layer.

11. The composite structural member of claim 10, wherein the angle δ is approximately forty-five degrees.

12. The composite structural member of claim 6, wherein the fiber reinforced substrate is a graphite fiber reinforced substrate.

13. The composite structural member of claim 1, wherein the first reinforced polymer-based substrate has a first thickness and the second reinforced polymer-based substrate has a second thickness that is different from the first thickness.

14. The composite structural member of claim 1, further comprising a first adhesive layer that bonds the first reinforced polymer-based substrate to a surface of the first flange portion, and a second adhesive layer that bonds the second reinforced polymer-based substrate to a surface of the second flange portion.

15. The composite structural member of claim 1, wherein the central structural portion is comprised of one of aluminum, titanium and steel.

16. A method of fabricating a composite structural member, comprising:
forming a web portion into a desired non-planar shape;
joining at least one flange portion to the web portion; and
joining a reinforced polymer-based substrate to the at least one flange portion.

16. The method of claim 16, wherein forming a web portion into a desired non-planar shape includes forming a web portion into at least one of a periodic undulating shape and a non-periodic undulating shape.

17. The method of claim 15, wherein forming a web portion includes imparting a sinusoidal shape to the web portion.

18. The method of claim 15, wherein joining at least one flange portion to the web portion comprises at least one of adhesively joining the flange portion to the web portion and fusing the flange portion to the web portion by a thermal fusion process.

19. The method of claim 15, further comprising preparing a surface of the at least one flange portion to receive an adhesive material using a sol-gel process.

20. An aerospace vehicle, comprising:
a fuselage;
wing assemblies and an empennage operatively coupled to the fuselage; and
a composite structural member positioned in at least one of the wing assemblies, the fuselage and the empennage, the composite structural member further comprising:
a central structural portion that extends in a first direction and having a first flange portion and a second flange portion that are spaced apart in a second direction perpendicular to the first direction by a web portion, the web portion further including a non-planar portion extending in the first direction;
a first reinforced polymer-based substrate fixedly coupled to the first flange portion; and
a second reinforced polymer-based substrate fixedly coupled to the second flange portion.

21. The aerospace vehicle of claim 20, wherein the non-planar portion comprises at least one of a periodic undulation portion and a non-periodic undulation portion.

22. The aerospace vehicle of claim 20, wherein the non-planar portion includes a periodic undulation comprising at least one of an approximately sinusoidal undulation, a triangular wave undulation and a square wave undulation.
